(19) United States
(12) Patent Application Publication
(10) Pub. No.: US 2025/0014485 A1
(43) Pub. Date: Jan. 9, 2025

(54) HOUSE NUMBER MOUNTING SYSTEM

(71) Applicant: THE HILLMAN GROUP, INC., Forest Park, OH (US)

(72) Inventors: Beth A. CASEY, West Chester, OH (US); Dale G. MALOTT, Gilbert, AZ (US); Hong Yuan YIN, Ontario (CA); Edward P. BUSAM, Mason, OH (US)

(21) Appl. No.: 18/739,904

(22) Filed: Jun. 11, 2024

Related U.S. Application Data
(60) Provisional application No. 63/511,986, filed on Jul. 5, 2023.

(51) Int. Cl. G09F 7/20; G09F 7/18

(52) U.S. Cl. CPC G09F 7/20; G09F 2007/1821; G09F 2007/1873

(57) ABSTRACT

An informational plaque mounting system includes a support bracket including a base having a rear side and a front side, and at least one first pivot component at the front side; an informational plaque including a plaque front side and a plaque rear side, and at least one second pivot component at the plaque rear side; wherein the at least one second pivot component is matingly engageable with the at least one first pivot component such that the informational plaque is supported on the support bracket and pivotable relative to the support bracket for varying an angular orientation of the informational plaque relative to the support bracket.

### TECHNICAL FIELD

This application relates generally to mounting hardware and, in particular, to a mounting system for house number plaques.

### BACKGROUND

Various types of house number mounting systems exist, including some floating number systems. In such floating systems, the house number plaques appear to “float” because the hardware used to mount the number plaques is not visible, at least when the house numbers are viewed straight on from a distance (e.g., when viewed from a road in front of a house on which the house number plaques are mounted). Problems with existing systems include the use of standoffs for the number plaques, the requirement for predrilling in most home sidings, the use of sealants and/or inability to adjust pitch and/or roll. Existing floating number mount systems require the use of 2 or more standoffs, increasing the number of installation steps, and require predrilling, which increases the chance of interference/misalignment of the standoff pins in siding. Existing products utilize paper templates for spacing and alignment of multiple number plaques, and cannot account for angled/lap sidings.

It would be desirable to provide house number mounting system that addresses one or more of the existing issues.

### SUMMARY

In one aspect, an informational plaque mounting system includes a support bracket including a base having a rear side and a front side, and at least one first pivot component at the front side; an informational plaque including a plaque front side and a plaque rear side, and at least one second pivot component at the plaque rear side; wherein the at least one second pivot component is matingly engageable with the at least one first pivot component such that the informational plaque is supported on the support bracket and pivotable relative to the support bracket for varying an angular orientation of the informational plaque relative to the support bracket.

In another aspect, an informational plaque mounting system includes a first support bracket including a first base having a rear side and a front side, and at least one first pivot component at the front side; a second support bracket including a second base having a rear side and a front side, and at least one first pivot component at the front side of the second base; wherein the first support bracket and the second support bracket are mounted side-by-side to a base structure; a first informational plaque including a plaque front side and a plaque rear side, and at least one second pivot component at the plaque rear side; a second informational plaque including a plaque front side and a plaque rear side, and at least one second pivot component at the plaque rear side of the second informational plaque; wherein the at least one second pivot component of the first informational plaque is matingly and releasably engaged with the at least one first pivot component of the first support bracket; wherein the at least one second pivot component of the second informational plaques is matingly and releasably engaged with the at least one first pivot component of the second support bracket.

In a further aspect, an informational plaque mounting system includes a first support bracket including a mount structure for mating with an informational plaque; a second support bracket including a mount structure for mating with an informational plaque; and an installation tool adapted for temporarily holding the first support bracket adjacent to and in alignment with the second support bracket.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1-17 show one embodiment of a house number mounting system;

FIGS. 18-22 show an alternative embodiment of support brackets and plaques for the house number mounting system; and

FIG. 23 shows an alternative embodiment of support brackets and plaques for the house number mounting system.

### DETAILED DESCRIPTION

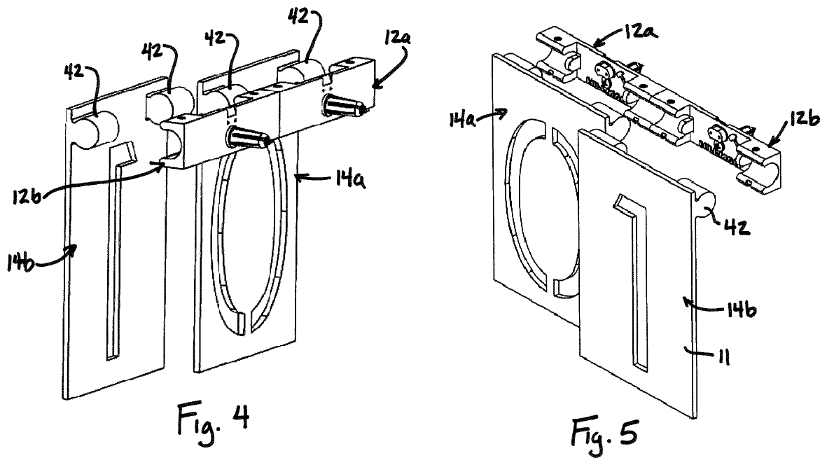

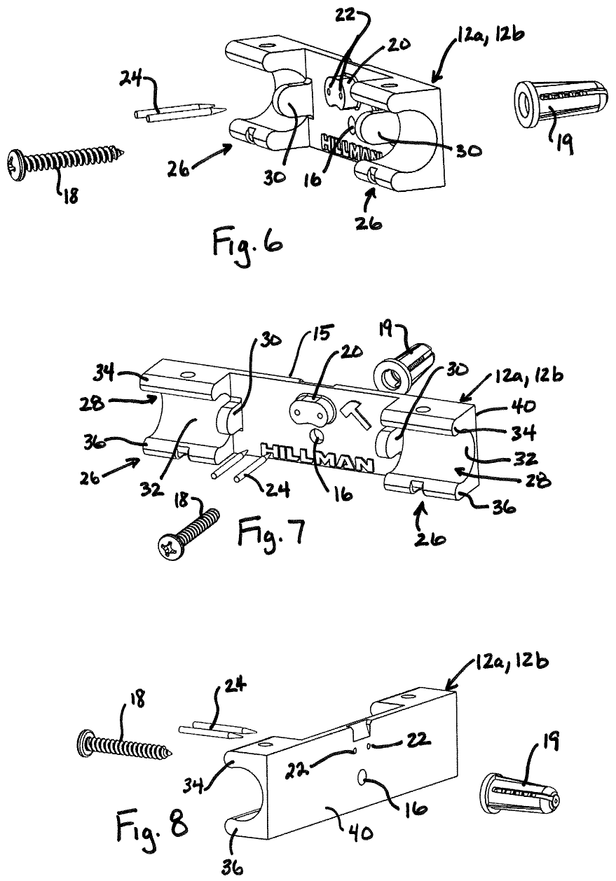

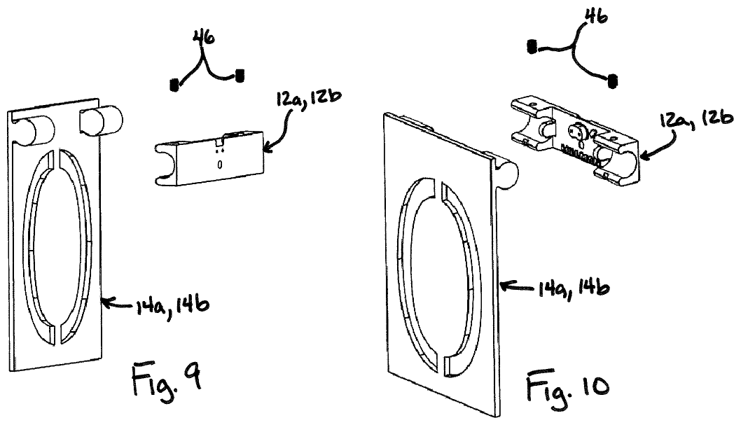

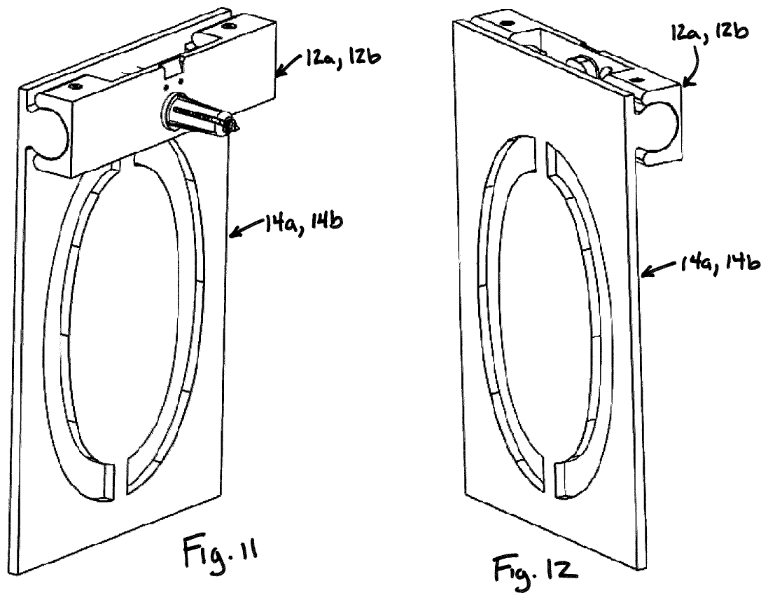

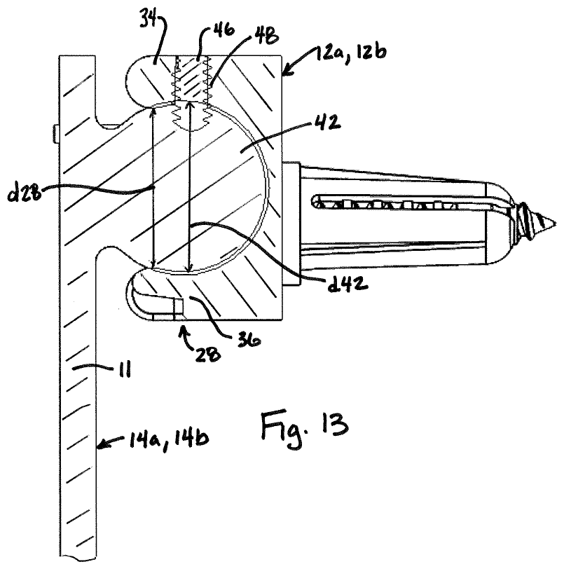

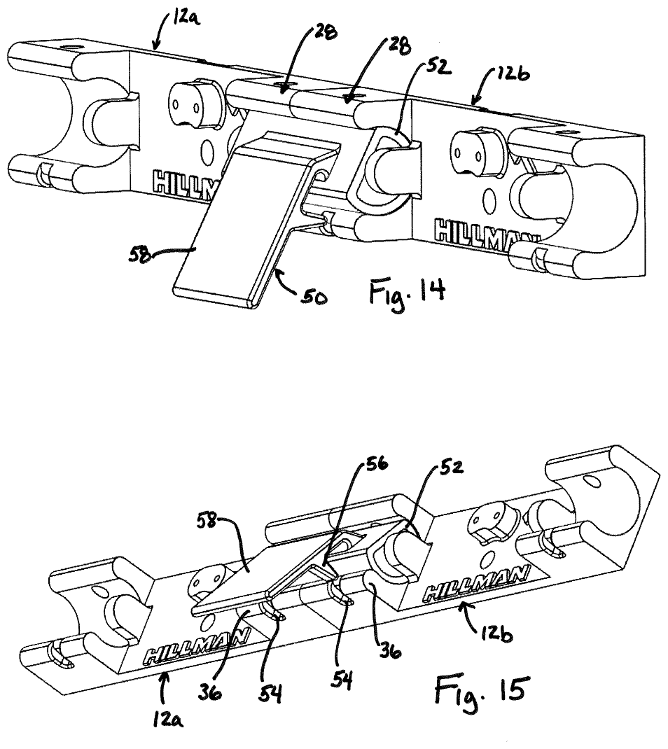

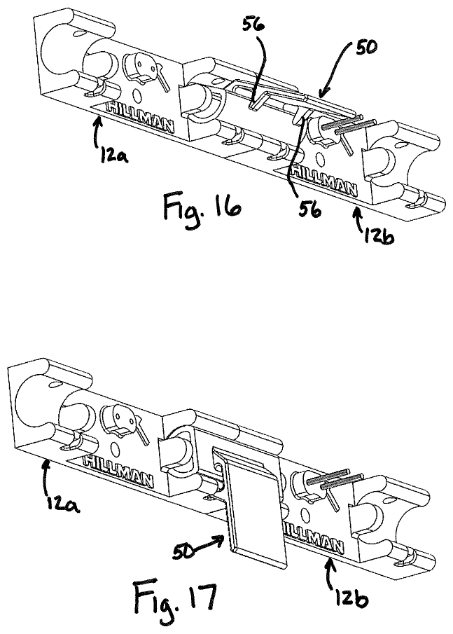

Referring to FIGS. 1-17, an embodiment of a house number plaque mounting system 10 includes support brackets 12a, 12b and corresponding house number plaques 14a, 14b mounted thereto. Although two brackets and corresponding plaques are shown, embodiments in which only one bracket and corresponding plaque are used, or in which three or more brackets and corresponding plaques are used, are also possible. In addition, although the illustrated embodiment includes one plaque per bracket, embodiments in which two or more plaques are mounted on a single support bracket are also possible.

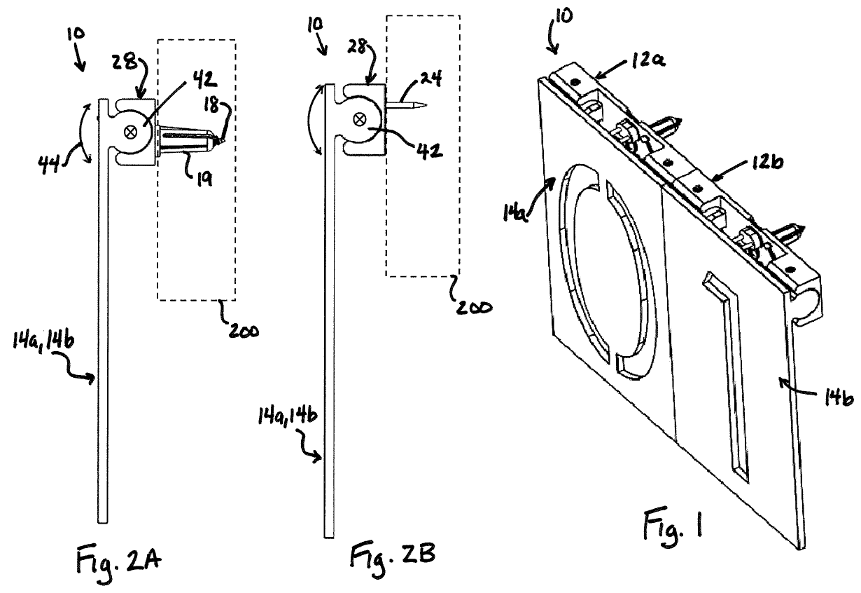

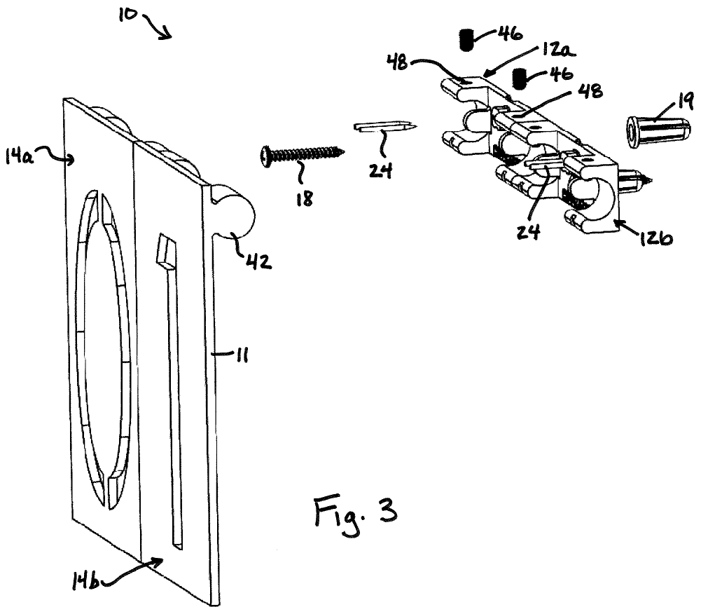

Each support bracket 12a, 12b includes a base 15 having a fastener opening 16 through which a threaded fastener 18 (with or without an anchor 19) may be placed for mounting the bracket to a base structure 200 (e.g., siding or masonry of a house), and also includes a pin projection 20 having pin openings 22 through which hardened pins 24 may be placed for the purpose of mounting, by hammering the pins 24 into the base structure 200 (cement, mortar, wood, and fiber cement sidings). A portion of each hardened pin 24 may be positioned within a respective one of the openings 22 prior to packaging and shipping of the mounting system components, with the protruding portion of each pin accessible for nailing (e.g., see the pins 24 of support bracket 12b in FIG. 3). However, the pins may be included separately in the system packaging as well. Thus, the illustrated support brackets include two different attachment options, threaded fasteners 18 or pins 24. However, embodiments in which only one of those options is provided are possible, and embodiments in which alternative attachment is facilitated (e.g., adhesive at the rear sides of the brackets), either with or without the threaded fastener and pin options, are also possible. FIG. 2A shows an exemplary installation utilizing the threaded fastener 18 (here with anchor 19), and FIG. 2B shows an exemplary installation utilizing only the hardened pins 24.

Each bracket 12a, 12b also includes spaced apart pivot mounts 26, each of which includes both a pivot barrel housing 28 and a side stop 30. Each pivot barrel housing functions as a female pivot component and is formed by an interior arcuate surface 32 running from an upper housing lip 34 to a lower housing lip 36, where the lips project forward of a rear mounting side 40 of the bracket.

Each number plaque 14a, 14b includes a main plate part 11 with a front side and a rear side, with spaced apart pivot pin components 42, which act as male pivot components, located at the rear side. The pivot components 42 are positioned and configured for mating into the barrel housings 28 of the bracket, allowing for pivot of the house number plaque relative to the bracket, per arrow 44, such that an angular orientation of the house number plaque, relative to the bracket and the surface to which the bracket is mounted, can be changed. In embodiments, the degree of pivot achievable by each house number plaque may be at least ten degrees, such as at least fifteen degrees, such as between ten and one-hundred ten degrees, but variations are possible. The angular orientation may be set via a friction fit between the pivot pin components 42 and the barrel housings 28 and/or by using set screws 46 that engage in openings 48 of the barrel housing to bear on the surface of the pivot components 42. The laterally inward sides of the pivot pin components 42 are positioned against or near (with some clearance) the laterally outward faces of the side stops 30 to assure proper lateral positioning of the house number plaque on the support bracket, preventing substantial lateral shift of the house number plaque. In the illustrated embodiment, each pivot component 42 is located toward or at the upper end of the house number plaque, but the pivot components 42 could be positioned anywhere along the height of the house number plaques.

The pin components 42 and barrel housings 28 are cooperatively shaped and configured such that the pin components 42 releasably snap-fit into the barrel housings. Here, the front entry dimension d28 of the pivot slot formed by each barrel housing is slightly smaller than the dimension d42 of the pin components to achieve the snap-fit feature. In embodiments, the support brackets are formed of a plastic, such as ABS or other stiff plastic. In other embodiments, a suitable resilient metal might be used, such as spring steel sheet.

Where multiple support brackets are used, it is important, from an aesthetic perspective, to properly align the support brackets side-by-side, as each is mounted independently to the base structure. For this purpose, per FIGS. 14-17, an installation tool 50 is provided, which includes a pivot component 52 configured for seating in the barrel housings 28 of the brackets 12a, 12b. The lower side of each housing lip 36 includes an upwardly inset slot 54, and the installation tool 50 includes spaced apart fingers 56. The mounting brackets 12a, 12b are placed side-by-side and the pivot component 52 of the tool is inserted into the adjacent barrel housings of the two brackets, per FIG. 16, and the tool is then rotated downward, via tool arm 58, such that the fingers 56 engage into the slots 54. The shape of the fingers 56 and the slots 54 is such that rotation of the tool into the position of FIG. 17 effectively squeezes together and aligns the two brackets, as the pivot component 52 simultaneously locks into the barrel housing via interaction of the shape of pivot component 52 with the housing lips 34, 36 (similar to the way in which pivot component 42 is held in the barrel housings as described above). The installation tool can be used to align and hold or lock together the two brackets before they are attached to the base structure. Alternatively, one bracket can be attached to the base structure, and then the installation tool used to align and lock or hold the second bracket to the first bracket until the second bracket is attached to the base structure. In either case, the tool 50 can be rotated back to the position of FIG. 16 and removed after both brackets have been attached to the base structure.

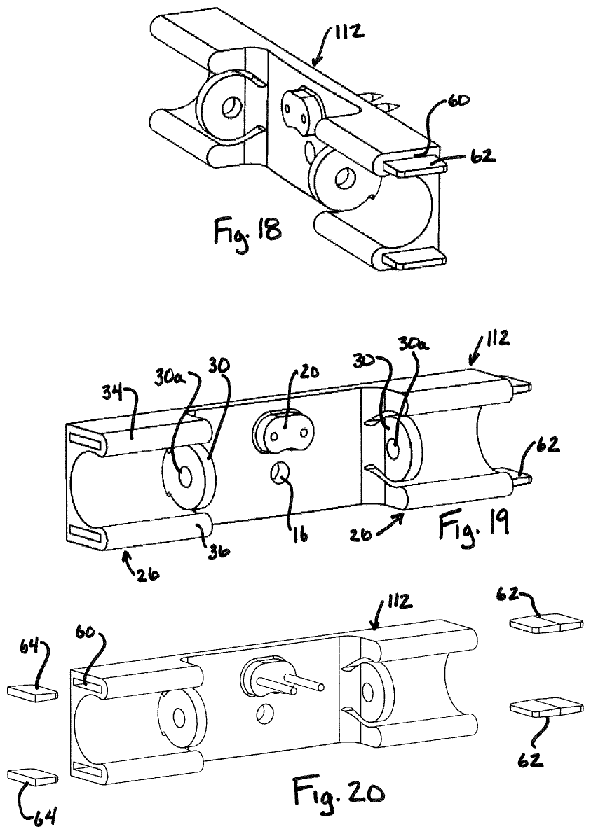

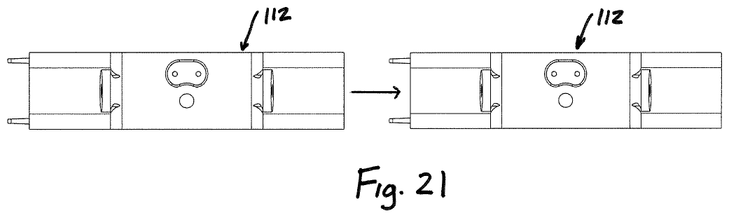

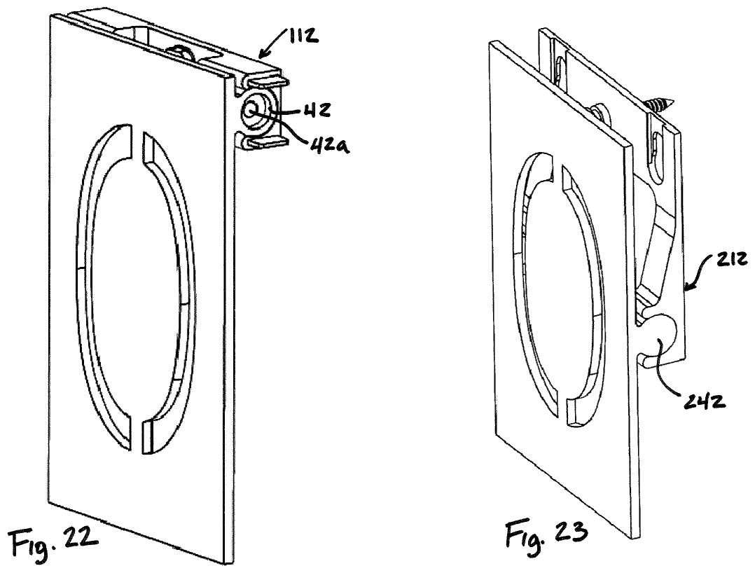

Referring now to FIGS. 18-22, an alternative configuration for the support brackets is shown. Here, the support brackets 112 include the same attachment features 16 and 20 as above, and the same pivot mounts 26 as above. However, for the purpose of support bracket alignment and positioning, the lateral sides of the barrel housing lips 34 and 36 include slots 60 into which mating biscuits 62 or finish biscuits 64 can be placed. In addition, the side stops 30 include openings 30a and the pivot components 42 of the number plaques include openings 42a, such that a threaded fastener can engage between the two for fixing the angular position of the number plaques.

Referring to FIG. 23, another alternative configuration for the support brackets is shown, where each support bracket 212 is substantially taller, creating a larger surface area at the rear side for base structure contact. The pivot mounts may be the same as either of the above embodiments. Here, the pivot components 242 of the number plaques are positioned along a middle region of the height of the plaques.

It is to be clearly understood that the above description is intended by way of illustration and example only, is not intended to be taken by way of limitation, and that other changes and modifications are possible. For example, although the systems above are described for use in mounting house number plaques (i.e., plaques with numbers or letters thereon), it is recognized that the systems could be used for mounting other types of plaques that carry information desired to be communicated by viewing (e.g., emojis or other images, such as animal shapes, or mascot shapes, or flags, etc.). The term “informational plaque” is used herein to refer to all such plaques (house number plaques and others).

As used herein, the term “kit” or “hardware kit” is used to refer to a set of components that are packaged together, regardless of the type of packaging (e.g., box, bag, jar or other container type). In one embodiment, a support bracket and house number plaque (or other informational plaque) are packaged together as a kit, in which case the hardened pins and/or the threaded fastener and anchor can also be included in the kit. Such a kit may also include the installation tool therein.

1. An informational plaque mounting system, comprising:
a support bracket including a base having a rear side and a front side, and at least one first pivot component at the front side;
an informational plaque including a plaque front side and a plaque rear side, and at least one second pivot component at the plaque rear side;
wherein the at least one second pivot component is matingly engageable with the at least one first pivot component such that the informational plaque is supported on the support bracket and pivotable relative to the support bracket for varying an angular orientation of the informational plaque relative to the support bracket.

2. The informational plaque mounting system of claim 1, wherein the at least one first pivot component is at least one first female pivot component and the at least one second pivot component is at least one male pivot component.

3. The informational plaque mounting system of claim 2, wherein the at least one female pivot component comprises a barrel housing projecting forwardly on the base, and the at least one male pivot component comprises a pin component projecting rearwardly from the informational plaque.

4. The informational plaque mounting system of claim 3, wherein the at least one first pivot component includes a side stop at one lateral side of the barrel housing.

5. The informational plaque mounting system of claim 3, wherein the barrel housing includes a set screw feature for releasably engaging the pin component for releasably fixing the angular orientation of the informational plaque relative to the support bracket.

6. The informational plaque mounting system of claim 3, wherein the barrel housing includes a slot feature for facilitating alignment of the mounting bracket with a second mounting bracket.

7. The informational plaque mounting system of claim 1, wherein the base carries a pin projection with at least one hardened pin positioned therein for attaching the support bracket to a base structure.

8. The information plaque mounting system of claim 1, wherein the at least one first pivot component comprises two spaced apart first pivot components, and the at least one second pivot component comprises laterally spaced apart second pivot components.

9. The informational plaque mounting system of claim 1, wherein the at least one second pivot component releasably snap-fits with the at least one first pivot component.

10. A kit, comprising the information plaque mounting system of claim 1.

11. The kit of claim 10, further comprising an installation tool component engageable with the support bracket.

12. An informational plaque mounting system, comprising:
a first support bracket including a first base having a rear side and a front side, and at least one first pivot component at the front side;
a second support bracket including a second base having a rear side and a front side, and at least one first pivot component at the front side of the second base;
wherein the first support bracket and the second support bracket are mounted side-by-side to a base structure;
a first informational plaque including a plaque front side and a plaque rear side, and at least one second pivot component at the plaque rear side;
a second informational plaque including a plaque front side and a plaque rear side, and at least one second pivot component at the plaque rear side of the second informational plaque;
wherein the at least one second pivot component of the first informational plaque is matingly and releasably engaged with the at least one first pivot component of the first support bracket;
wherein the at least one second pivot component of the second informational plaques is matingly and releasably engaged with the at least one first pivot component of the second support bracket.

13. The informational plaque mounting system of claim 12, wherein a lateral side of the first support bracket abuts a lateral side of the second support bracket.

14. The informational plaque mounting system of claim 13, wherein an attachment of the first support bracket to the base structure is independent of an attachment of the second support bracket to the base structure.

15. The informational plaque mounting system of claim 12, wherein the first informational plaque is pivotably movable relative to the first support bracket, wherein the second informational plaque is pivotably movable relative to the second support bracket, wherein the second informational plaque is pivotable independently of the first informational plaque.

16. An informational plaque mounting system, comprising:
a first support bracket including a mount structure for mating with an informational plaque;
a second support bracket including a mount structure for mating with an informational plaque;
an installation tool adapted for temporarily holding the first support bracket adjacent to and in alignment with the second support bracket.

17. The informational plaque mounting system of claim 16, wherein:
the first support bracket includes a female pivot component;
the second support bracket includes a female pivot component;
the installation tool engages with both the female component of the first support bracket and the female component of the second support bracket for temporarily holding the first support bracket adjacent to and in alignment with the second support bracket.

18. The informational plaque mounting system of claim 17, wherein the installation tool includes projections that engage with slots on the female components of the first and second support brackets for temporarily holding the first support bracket adjacent to and in alignment with the second support bracket.
